(19) United States
(12) Patent Application Publication
(10) Pub. No.: US 2007/0214430 A1
(43) Pub. Date: Sep. 13, 2007

(54) Textpane for pushed and pulled information on a computing device

(76) Inventor: Daryl David Coutts, Edmonton (CA)

Correspondence Address: BEYER WEAVER LLP, P.O. BOX 70250, OAKLAND, CA, 94612-0250, US

(21) Appl. No.: 11/472,132

(22) Filed: Jun. 20, 2006

Related U.S. Application Data
(60) Provisional application No. 60/779,654, filed on Mar. 7, 2006.
(60) Provisional application No. 60/796,185, filed on May 1, 2006.
(60) Provisional application No. 60/801,395, filed on May 19, 2006.
(60) Provisional application No. 60/809,831, filed on Jun. 1, 2006.

(51) Int. Cl. G06F 3/048; G06F 15/16

(52) U.S. Cl. 715/774; 709/204

(57) ABSTRACT

A method comprises obtaining text segments from information pushed to a computing device and displaying the text segments in a textpane on a display associated with the computing device. The method further comprises obtaining text segments from information pulled to the computing device and displaying them in the textpane as well. Still further, the method comprises responding to a user indication directed at a particular text segment displayed in the textpane, by launching an application or sending a message from a first application to a second application. By integrating both pushed and pulled information into the same textpane, screen real estate on the display of a computing device is conserved. A computer user is then able to monitor a large number of disparate information sources while they focus their work in a particular application.

### CROSS REFERENCE TO RELATED APPLICATIONS

This application claims the benefit of priority under 35 USC 119(e) to U.S. Provisional Application No. 60/779,654, filed Mar, 7, 2006, entitled “PERSONAL NOTIFICATION LOG WITH DISPLAY PANE”; U.S. Provisional Application No. 60/796,185, filed May 1, 2006, entitled “DISPLAY PANE FOR PUSH AND PULL INFORMATION SOURCES”; U.S. Provisional Application No. 60/801,395, filed May 19, 2006, entitled “DISPLAY AREA FOR PUSH AND PULL INFORMATION ON A COMPUTING DEVICE”; U.S. Provisional Application No. 60/809,831, filed Jun. 1, 2006, entitled “DISPLAY AREA FOR PUSH AND PULL INFORMATION ON A COMPUTING DEVICE”; and U.S. Provisional Application No. 60/______, filed Jun. 19, 2006, entitled “TEXTPANE FOR PUSHED AND PULLED INFORMATION ON A COMPUTING DEVICE”, all of which are incorporated herein by reference in their entirety.

### TECHNICAL FIELD

This invention pertains to computerized methods and systems for displaying information on a user's computing device.

### BACKGROUND OF THE INVENTION

Today, a computer user's display is a very busy environment. The typical user has many applications running on their computer. Email, word processing, spreadsheet, instant messaging, calendar, stock portfolio, newsreader, location and even process control. As a user is trying to complete a task, they are focused on one particular application, but the other applications continue to work in the background. These background applications can send notifications to the user's screen at any moment. A user often has to attend to this notification, simply to determine the notification contents. This takes the user away from the task they are focussed on. This is very intrusive. An example is when a user is working on a document in a word processor. They receive an instant message notification that is usually a flashing rectangle at the bottom of their screen and an accompanying audio herald. To determine the contents of the instant message, the user must click on the flashing rectangle at the bottom of the screen, which then expands to an instant messaging conversation window. The user then must minimize the conversation window and return to the word processor application. The instant message notification has notably disrupted the user's work in the word processor application.

Nawaz in U.S. Pat. No. 6,421,694, teaches the display of notifications in a ticker display pane similar to that illustrated in FIG. 1 a. Ticker panes repeat notifications periodically to increase the chance that a user will see the notification, but unless the user is looking at the ticker pane when a particular notification goes by, they will miss it. Another drawback with ticker panes is that because they repeat notifications periodically, old notifications are sometimes displayed next to new notifications. This lack of time order, in notification display, makes review of historic notifications difficult. Further, Nawaz method only displays retrieved or pulled information—it does not handle pushed information.

Email and newsreader programs typically use notification balloons in the corner of the computer display screen. These notifications are transitory. If a user is not looking at the corner of the screen at the moment of the notification's arrival, the user will miss the notification. If a user is away from their computer while at lunch, they will miss all the notification balloons. Users do not trust that they have seen all their required notification balloons so they resort to manually checking all their applications for fresh notifications. The user checks their email application for the email they are expecting, they check their phone program to see who has called, they check their portfolio program for value of their portfolio, they check their newsgroup program to see if someone has responded to their question. All of this checking takes a lot of effort. To go through this checking cycle a user must click on the email icon to switch to their email inbox, examine their inbox, then click on the phone icon to switch to their phone inbox, examine their phone inbox, then click on the portfolio icon to switch to their portfolio application, examine their portfolio, then click on the newsgroup icon to switch to their newsgroup inbox and so on.

What is needed is a system and method such that a computer user can monitor a large number of notifications in one place. The display of notifications should be minimally disruptive to the user's current task. The computer user needs be able to act on notifications quickly, easily transitioning to the application associated with the notification. The notifications should persist so the computer user can review them at their convenience. The display of the historic notifications should facilitate rapid review by the user.

### BRIEF SUMMARY OF THE INVENTION

A method of the invention comprises obtaining text segments from information pushed to a computing device and displaying the text segments in a textpane on a display associated with the computing device. The invention further comprises obtaining text segments from information pulled to the computing device and displaying them in the textpane as well. Still further, the invention comprises responding to a user indication directed at a particular text segment displayed in the textpane, by launching an application or sending a message from a first application to a second application.

By integrating both pushed and pulled information into the same textpane, screen real estate on the display of a computing device is conserved. A computer user is then able to monitor a large number of disparate information sources while they focus their work in a particular application.

The text segments can be displayed in the textpane with more recently added text segments appearing below less recently added text segments or vice versa. Also, the textpane can be made user scrollable. These features facilitate rapid review of notifications by the computer user. If a user has been away from their computer for a lunch, upon their return, they can easily scroll the textpane to review the text segments added during their absence.

Text segments are added to the textpane when new information is received, this is an improvement over the prior art event viewer in FIG. 1B that only updates its display in response to user input.

The textpane can be made to go partially transparent after a period of time without receiving new information or without user interaction. This also reduces effective screen real estate.

### BRIEF DESCRIPTION OF THE DRAWINGS

The drawings constitute part of this specification and include exemplary embodiments to the invention, which may be embodied in various forms. It is to be understood that in some instances various aspects of the invention may be shown exaggerated or enlarged to facilitate an understanding of the invention.

FIG. 1a shows a prior art ticker pane.

FIG. 1b illustrates a prior art event log.

FIG. 2 illustrates an exemplary computing device receiving information from push and pull information sources.

FIG. 3a shows an example text segment, and also a timestamp and icon with the text segment

FIG. 3b illustrates a textpane for displaying plural rows of text segments.

FIG. 4 shows a textpane displaying text segments on a computer screen.

FIG. 5 illustrates an example of what happens when a user clicks on a particular text segment.

FIG. 6 shows flowcharts of some methods of the invention.

FIG. 7 shows a flowchart of another method of the invention.

FIG. 8 shows a window with a textpane dedicated to pulled information and a textpane dedicated to pushed information.

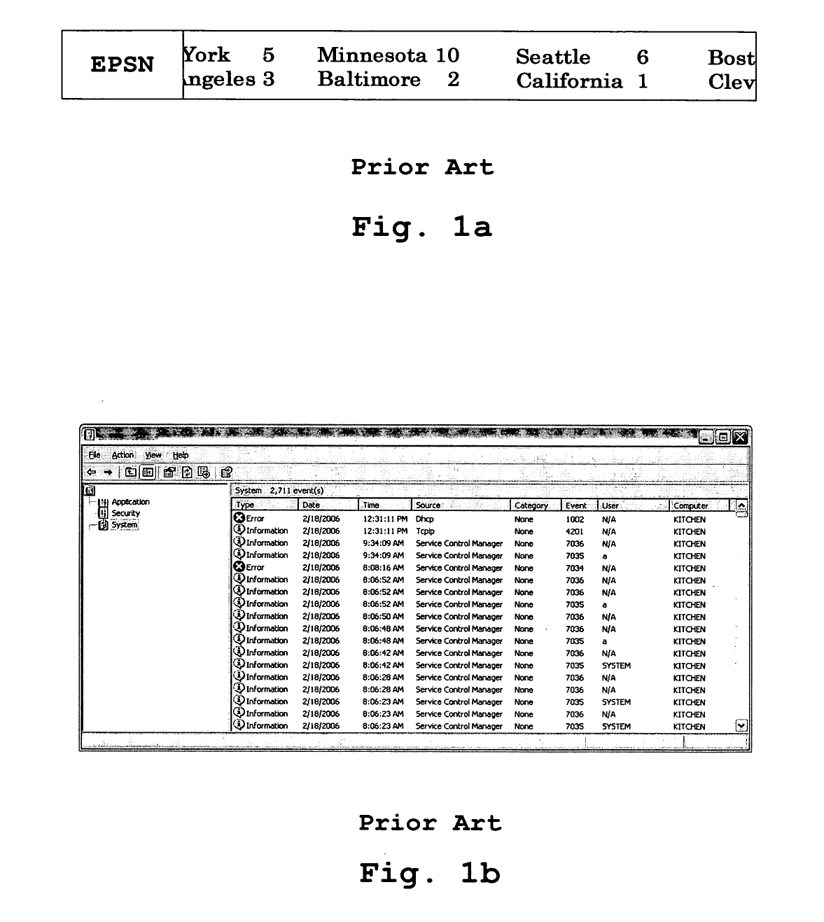

### DETAILED DESCRIPTION OF THE INVENTION

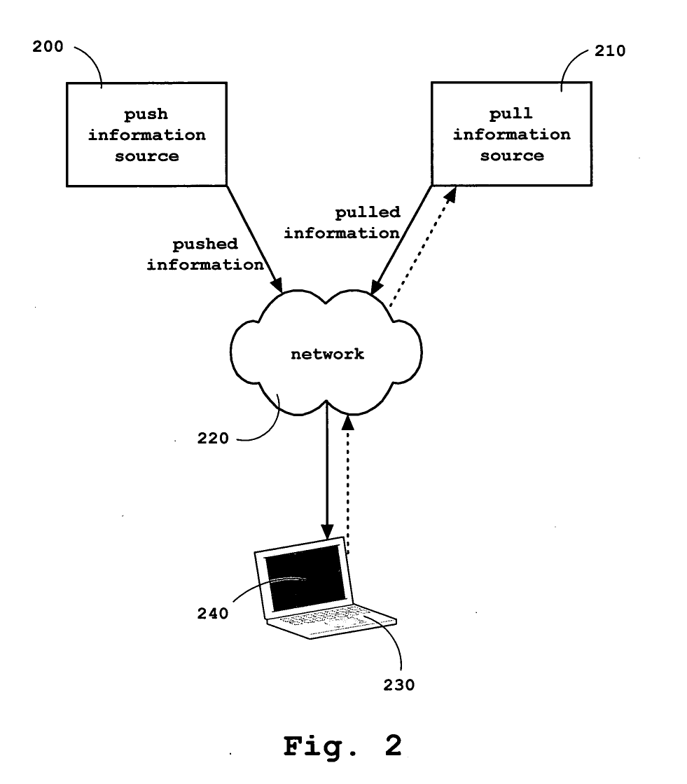

FIG. 2 shows a computing device 230 coupled via a network 220 to a push information source 200 and a pull information source 210. Only one information source of each type is shown, but there could of course be more than one information source of each type. The computing device 230 can be any suitable computing device examples of which include: cellphone, handheld, PDA, desktop computer, notebook computer. Other kinds of computing devices are within the scope of the invention. The computing device 230 has a display 240. The network 220 is any type of network, examples of networks include: internet, cellular network, home network, ether network. Other kinds of networks are within the scope of the invention.

Pulled information is information received at the computing device 230 in response to a particular request for information sent from the computing device 230. The dotted arrow in FIG. 2 represents the request for information. An example of pulled information would be the information received at a computing device 230 in response to a request for a webpage from a webpage server. A pull information source 210 has the characteristic that it sends information to a computing device 230 in response to a request for information from the computing device 230. An example of a pull information source would be a webpage server or a POP3 email server. Other examples of pull information sources are of course possible and are within the scope of the invention.

Pushed information is information received at the computing device 230 that is not pulled information. An example of pushed information could be an instant message received at a computing device 230. A push information source 200 has the characteristic that it will send information, without prompting, to a computing device 230. A typical example of a push information source 200 is an instant messaging server when it sends information to a client device. (Instant messaging servers can also be pull information sources 210 if the instant messaging protocol is implemented using HTTP but this is not a typical mode.) Other examples of push information sources are of course possible and are within the scope of the invention.

Note in FIG. 2 that the information sources 200 and 210 are external to the computing device 230.

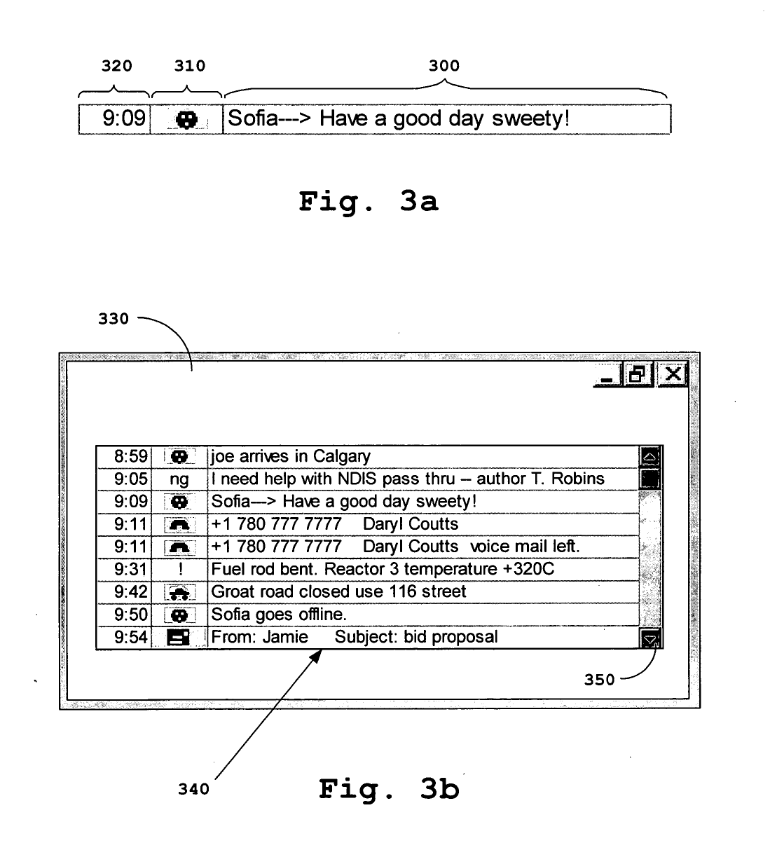

FIG. 3a shows an example text segment 300 along with an icon 310 and a time stamp 320. The icon 310 and the timestamp 320 are optional and need not be displayed when the text segment 300 is displayed. Also in FIG. 3a, border lines are shown around the text segment 300, icon 310 and time stamp 320, these border lines are optional as well. An icon 310 or a time stamp 320 or other display items could be displayed along with a text segment 300. A text segment 300 is at least three characters long.

FIG. 3b illustrates a textpane 340. A textpane 340 is an area established on the display 240 associated with the computing device 230. A textpane 340 can be in a window 330 of a graphical user interface as illustrated in FIG. 3b or it can be part of a desktop on the display 240 of the computing device 230. The textpane 340 can be part of a sidebar on the display 240 of the computing device 230. A textpane 340 displays plural rows of text segments 300 in an integrated manner. Some of the text segments 300 displayed in the textpane 340 are derived from pushed information received by the computing device 230 and some of the text segments displayed in the textpane 340 are derived from pulled information received by the computing device 230. A textpane 340 is not precluded from displaying non-text items such as icons.

If the textpane 340 is implemented with a user interface component that displays a subset of a list, each text segment 300 can be added as an item to the list. Also, the time stamps 320 and icons 310 can be part of items added to the list. Example user interface components that could be used to implement the textpane 340 include: List, ListBox, ListView, ComboBox, RichTextBox,TextBox, TextArea, TextPane, and TextEditorPane.

If the textpane 340 is implemented with a user interface component that displays a subset of a data grid or a subset of a data table, each text segment 300 can be an entry in the table. Similarly, the time stamps 320 and icons 310 can be entries in the table. Example user interface components that could also be used to implement the textpane 340 include: DataGrid and DataGridView.

Other ways to provide the textpane 340 are possible. The textpane 340 can be provided by a tile of a sidebar. The textpane 340 can be provided by a panel of a sidebar. The textpane 340 can be provided by a mini-application like a widget or a gadget.

FIG. 3b shows examples of the kinds of text segments 300 that might be displayed in the textpane 340. FIG. 3b shows the text segment “joe arrives in Calgary” derived from information pushed to the device 230. It was added to the textpane 340 at 8:59. The push information source 200 in this case was a location server. At 9:05, the text segment “I need help with NDIS pass thru—author T. Robins” derived from information pulled to the device, was added to the textpane 340. The pull information source 210 in this case was a newsgroup server. At 9:09, the text segment “Sofia→ Have a good day sweety!” derived from information pushed to the device 230, was added to the textpane 340. In this case, the text segment was derived from pushed information from an instant messaging server—a push information source 200. Other examples of text segments are shown in FIG. 3b. At 9:54 the text segment “From: Jamie Subject: bid proposal” is added to the textpane 340. In this case the text segment is derived from information pulled to the device 230 from a POP3 email server—a pull information source 210.

In FIG. 3b the text segments are shown in the textpane 340 in time order. More recently added text segments are displayed below (in the plane of the display 240) less recently added text segments throughout the textpane 340. This time ordering could be reversed with more recently added text segments being displayed above (in the plane of the display 240) less recently added text segments throughout the textpane 340.

FIG. 3 is an example—items can be added or removed from the window 330 and textpane 340 without departing from the invention. The timestamps, icons and scrollbars are optional. Also, there does not need to be gridlines separating the text segments that are shown in the textpane 340. Also of course the textpane 340 could be a different size and the number of text segments 300 displayed in the the textpane 340 could be different. Other elements could be added and taken away from the textpane without departing from the invention.

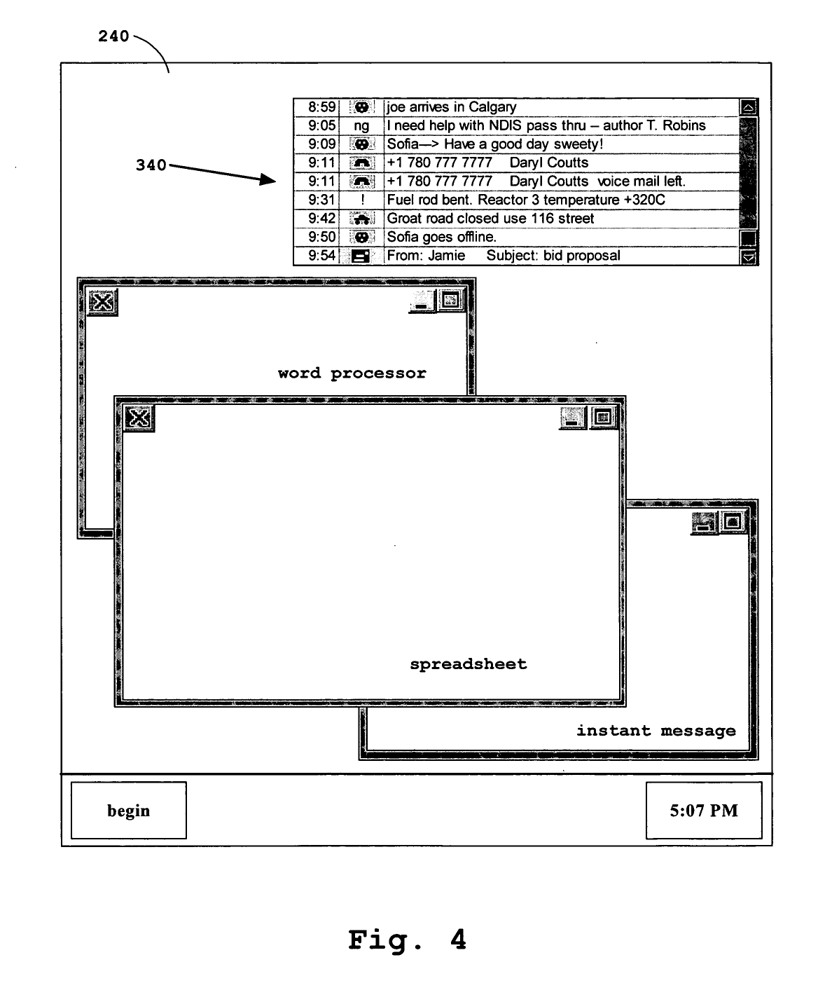

The textpane 340 could completely cover the window 330 as shown in FIG. 4. FIG. 4 shows an exemplary textpane 340 as it might appear on the display 240 of a computing device 230. By having the textpane 340 completely cover the window 330, the screen footprint is reduced. The functionality of minimizing, maximizing, closing and other graphical user interface functionality can be presented to the user as a pop-up menu that the user can initiate with a right-click action over the textpane 340. In an alternative embodiment, the textpane 340 could be part of a defined region on a desktop provided by the operating system of the computing device 230 rather than being contained in a window 330. FIG. 4 illustrates how a user can monitor notifications and messages in the textpane 340 while still working in other applications such as word processing or spreadsheets.

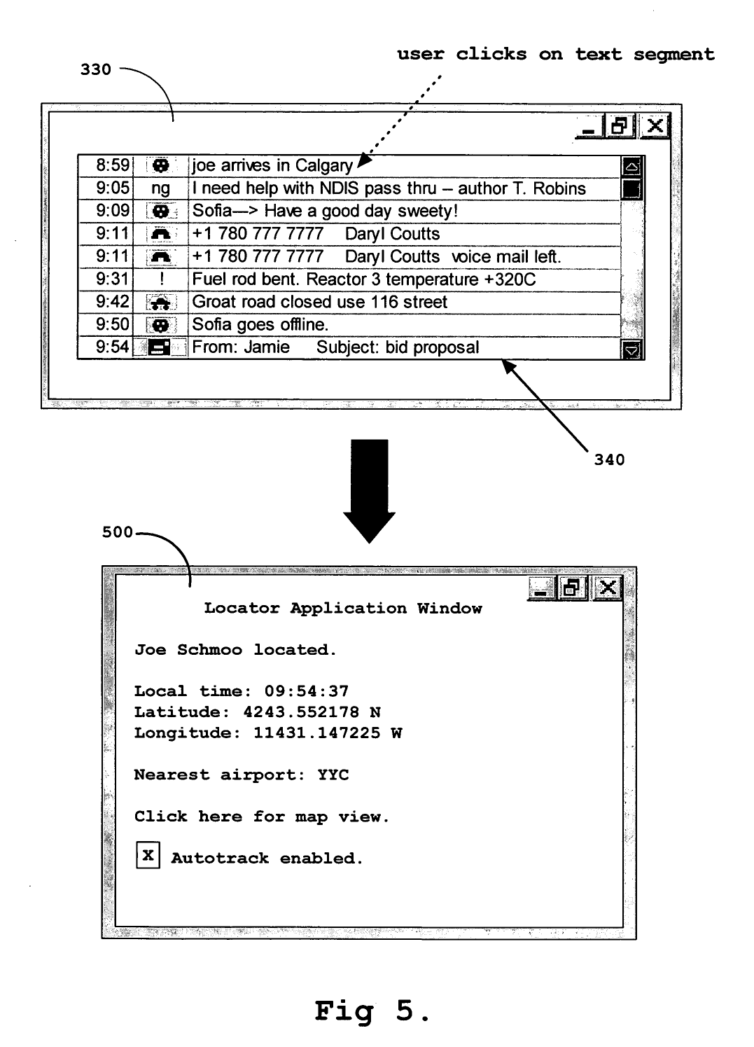

FIG. 5 illustrates what happens when a user clicks on a text segment 300 displayed in the window 330. After the user clicks on a text segment 300, an application is launched, or a message is sent from a first application to a second application or a message is sent from a first process to a second process. A message can be sent from a first application to a second application using IP (internet protocol). A message can also be sent from a first application to a second application by having the first application cause a function or procedure of the second application to be invoked. There are many other ways for a first application to send a message to a second application. Similarly, there are many ways to send a message from a first process to a second process.

For the purpose of this document, the action of launching an application, or sending a message from a first application to a second application, or sending a message from a first process to a second process is termed accessing a resource.

In the example of FIG. 5, the user has clicked on the “joe arrives in Calgary” text segment 300. This causes a message to be sent to a location application running on the computing device 230.

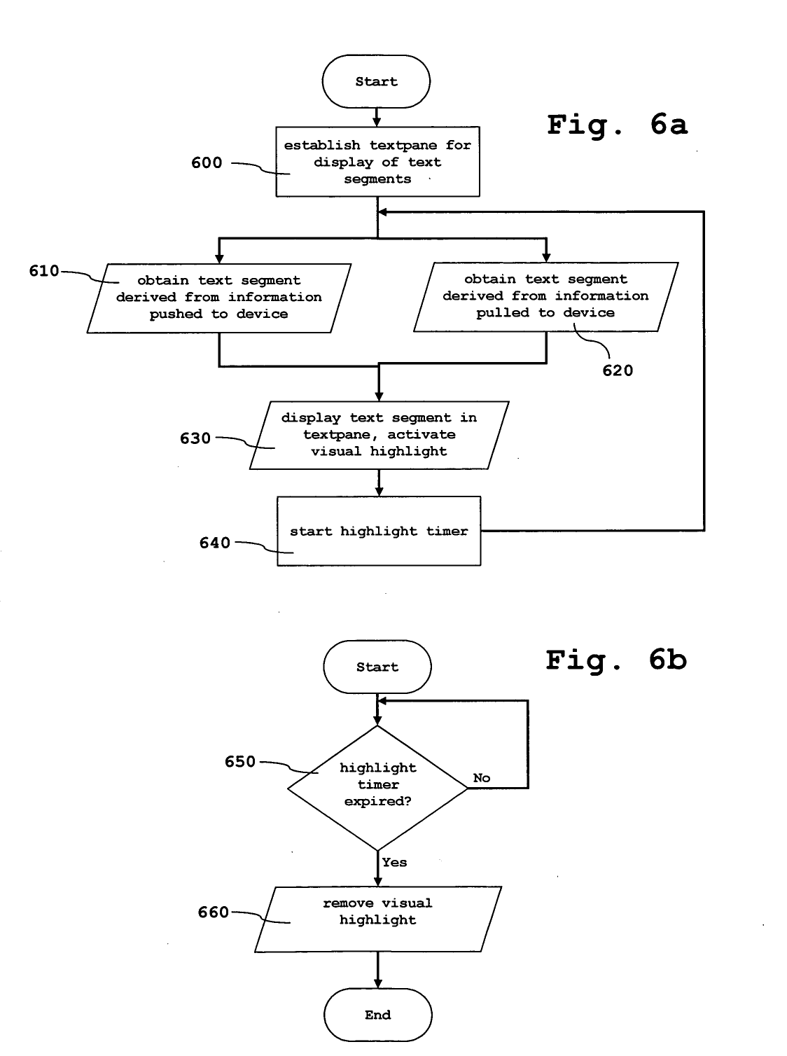

FIG. 6a shows a flowchart of a method of the invention. In step 600, the textpane 340 is established on the display screen of the computing device 230. In step 610, a text segment 300 derived from information pushed to the device 230 is obtained. In step 630, the text segment 300 is displayed in the textpane 340. In step 620, a text segment 300 derived from information pulled to the device 230 is obtained, which is then displayed when step 630 is executed. Optionally, in step 630, a visual highlight can be displayed, such as displaying the text segment in reverse video—this draws attention to the newly displayed text segment. Other visual highlights or no highlights could be used in step 630. Step 640 is executed if a visual highlight is used.

FIG. 6b is a flowchart of another method of the invention. In step 650, a timer is monitored and when the timer expires, the visual highlight is turned off—step 660.

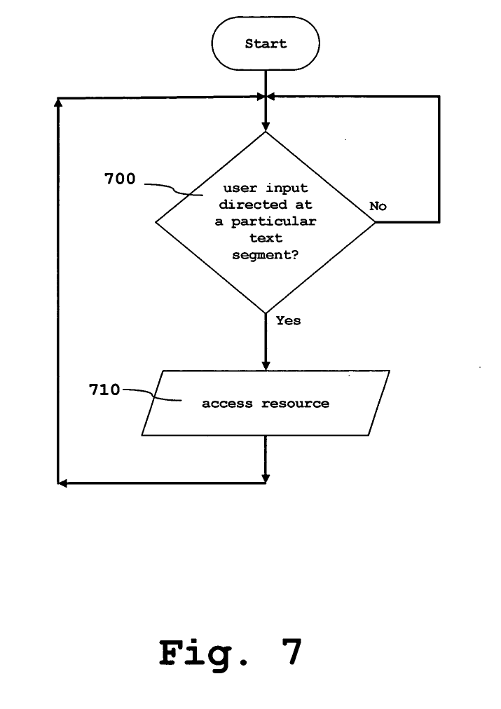

FIG. 7 is a flowchart of another method of the invention. In step 700, the text segments 300 displayed in the textpane 340 are monitored for user input. When user input is detected, step 710 is executed whereby a resource is accessed. Typically, the user input will be a single click of a mouse but other user inputs fit with the invention. Example other user inputs include a double click of a mouse, tap with a stylus and tap with a finger. Step 710 can comprise the additional step of displaying an interim user interface element that requires another indication from a user before the resource is accessed.

In FIG. 6 and FIG. 7, not all steps are required for the invention. Also, other steps could be added without departing from the invention.

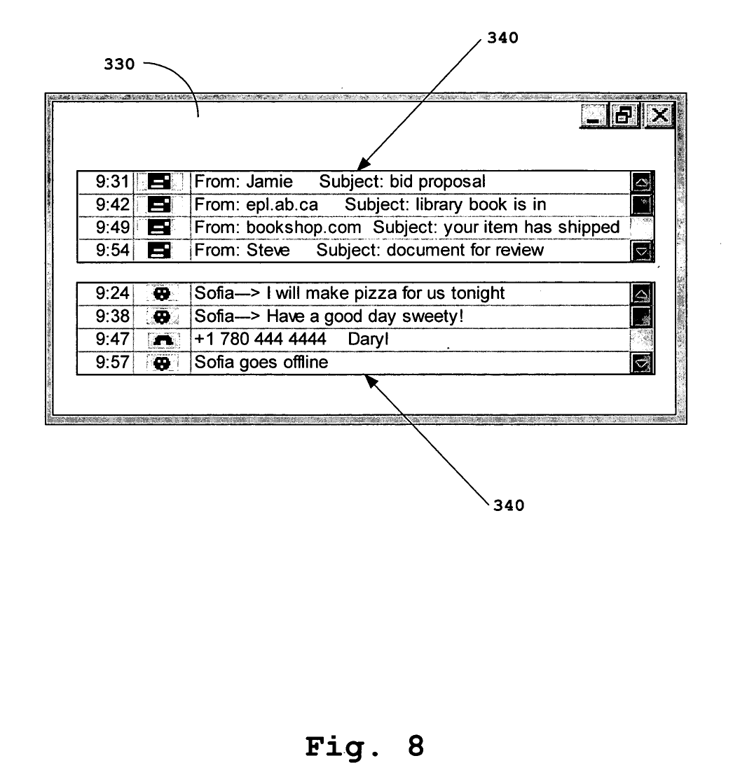

FIG. 8 shows an example of a window 330 that has two textpanes 340, where one textpane 340 is dedicated to pulled information and one textpane 340 is dedicated to pushed information. The upper textpane 340 is displaying text segments 300 which are derived from emails received at the computing device 230—pulled information. The lower textpane 340 is displaying text segments derived from instant messages and phone calls received at the computing device 230—pushed information. A sidebar on a display 240 associated with a computing device 230 could have one textpane 340 dedicated to pushed information and one textpane 340 dedicated to pulled information. The textpanes 340 could be part of a defined region on a desktop provided by the operating system of the computing device 230.

While various embodiments have been described above, it should be understood that they have been presented by way of example only, and not limitation. For example, any of the elements associated with the display area for push and pull information sources may employ any of the desired functionality set forth hereinabove. Thus, the breadth and scope of a preferred embodiment should not be limited by any of the above-described exemplary embodiments.

What is claimed is:

1. A method of handling notifications to a user of a computing device, comprising:
at the computing device, receiving pushed information and pulled information;
providing a textpane on a display associated with the computing device;
within the textpane, displaying at least one text segment derived from the pushed information and displaying at least one text segment derived from the pulled information, wherein the text segments are displayed in an integrated, time ordered manner; and
receiving a plurality of indications of user interaction with the displayed derived text segments and causing a resource associated with a displayed derived text segment to be accessed based on an indication of user interaction with the displayed derived text segment being received.

2. The method of claim 1 wherein:
the pushed information includes at least one of information relative to a received instant message, to a received phone call, and an alarm indication.

3. The method of claim 1 wherein:
the pulled information includes at least one of information relative to a received email, to a received web page, and a received newsgroup posting.

4. The method of claim 1 further comprising:
when a text segment is first displayed in the textpane, that text segment is displayed below previously displayed text segments in the plane of the display.

5. The method of claim 1 further comprising:
when a text segment is first displayed in the textpane, that text segment is displayed above previously displayed text segments in the plane of the display.

6. The method of claim 1, wherein:
when a text segment is first displayed in the textpane, the text segment is displayed in reverse video for a period of time and is displayed in non-reverse video thereafter.

7. The method of claim 1, wherein:
the textpane becomes at least partially transparent upon occurrence of a specified condition.

8. The method of claim 7, wherein:
the specified condition includes passage of a specified period of time with no pushed information or pulled information received and with no indications of user interaction received.

9. The method of claim 1, wherein:
the user interaction is one of a single click of a mouse and a single tap of a stylus.

10. The method of claim 1 wherein:
the step of causing a resource associated with a displayed derived text segment to be accessed further comprises displaying a user interface element and receiving an indication of user interaction with the user interface element.

11. The method of claim 1 wherein:
the step of causing a resource to be accessed further comprises sending a message from a first application to a second application where the first application and second application are executing on the computing device.

12. The method of claim 1, wherein:
the textpane is implemented using a user interface component selected from one of a ListBox, ListView, ComboBox, RichTextBox, TextBox, DataGridView, DataGrid, ScrollPane, SplitPane, TabbedPane, TextArea, TextPane, and EditorPane.

13. The method of claim 1, wherein:
the textpane is provided by a widget or gadget.

14. The method of claim 1, wherein:
the textpane is integrated within a tile or panel.

15. A method of handling notifications to a user of a computing device, comprising:
at the computing device, receiving pushed information and pulled information;
providing a first textpane and a second textpane within a defined region of a display associated with the computing device;
within the first textpane, displaying a text segment derived from at least some of the received pushed information and, within the second textpane, displaying a text segment derived from at least some of the received pulled information, wherein the text segments are displayed within each text pane in a time ordered manner; and
receiving a plurality of indications of user interaction with the displayed derived text segments and causing a resource associated with a displayed derived text segment to be accessed based on an indication of user interaction, with the displayed derived text segment, being received.

16. The method of claim 15, wherein:
the defined region is one of a sidebar and a window.

17. The method of claim 16 wherein:
the step of causing a resource associated with the particular text segment to be accessed further comprises displaying a user interface element and receiving an indication of user interaction with the user interface element.

18. The method of claim 17, wherein:
each of the textpanes are implemented using a user interface component selected from one of a ListBox, ListView, ComboBox, RichTextBox, TextBox, DataGridView, DataGrid, ScrollPane, SplitPane, TabbedPane, TextArea, TextPane, and EditorPane.

19. The method of claim 17, wherein:
each of the textpanes is provided by a widget or gadget.

20. The method of claim 17, wherein:
each of the textpanes is integrated within a tile or panel.
